(19) United States
(12) Patent Application Publication
(10) Pub. No.: US 2015/0039796 A1
(43) Pub. Date: Feb. 5, 2015

(54) ACQUIRING RESOURCES FROM LOW PRIORITY CONNECTION REQUESTS IN SAS

(71) Applicant: LSI CORPORATION, SAN JOSE, CA (US)

(72) Inventors: Vidyadhar Pinglikar, Pune (IN); Shankar T. More, Pune (IN)

(73) Assignee: LSI CORPORATION, SAN JOSE, CA (US)

(21) Appl. No.: 14/173,488

(22) Filed: Feb. 5, 2014

(30) Foreign Application Priority Data
Aug. 1, 2013 (IN) 3473/CHE/2013

(51) Int. Cl. G06F 13/42

(52) U.S. Cl. CPC G06F 13/4282
USPC 710/114

(57) ABSTRACT

Systems and methods herein provide for managing connection requests through a Serial Attached Small Computer System Interface (SAS) expander. In one embodiment, the expander receives a low priority open address frame (OAF) that includes a source address and a destination address. The expander also receives a high priority OAF that includes a source address and a destination address. The high priority OAF requires at least a portion of a partial path acquired by the low priority OAF for which connection request arbitration is in progress. The expander determines whether the high OAF source address matches the low OAF destination address, and in response to a determination that the high OAF source address is different than the low OAF destination address, acquires pathway resources from the low priority OAF and forwards the high priority OAF in accordance with its destination address.

This document claims priority to Indian Patent Application No. 3473/CHE/2013 (filed on Aug. 1, 2013) entitled ACQUIRING RESOURCES FROM LOW PRIORITY CONNECTION REQUESTS IN SAS, which is hereby incorporated by reference.

### FIELD OF THE INVENTION

The invention generally relates to managing connection requests in a Serial Attached Small Computer System Interface (SAS) environment.

### BACKGROUND

The SAS protocol uses a series of commands to communicate between devices in a data system. Before a connection is established between two devices, a source device (i.e., the device from which a service delivery transaction originates) makes a request to establish a connection by transmitting an open address frame (OAF) to a destination device (i.e., the device to which a service delivery transaction is addressed). An OAF typically contains a source address, a destination address, and other attributes that help expanders route data in the SAS architecture. When two different OAFs need to use the same pathway, an OAF with high priority will cause an OAF with low priority to release path resources and make way for the high priority OAF, but only if the source address of the high priority OAF is equal to the destination address of the low priority OAF. In the case when a device sends a high priority OAF with a source address not equal to the low priority OAF's destination address (and the device requires some or all of the pathway acquired by the low priority OAF), the high priority OAF waits for the low priority OAF to complete processing, thereby delaying the high priority OAF in favor of the low priority OAF.

### SUMMARY

Systems and methods presented herein provide for managing connection requests in a Serial Attached Small Computer System Interface (SAS) environment. The SAS expander includes a processor adapted to receive a low priority open address frame that includes a source address and a destination address, and to receive a high priority open address frame that includes a source address and a destination address. The high priority open address frame requires at least a portion of a partial path acquired by the low priority address frame for which connection request arbitration is in progress. The processor is further operable to determine whether the high priority open address frame source address matches the low priority open address frame destination address, and in response to a determination that the high priority open address frame source address is different than the low priority open address frame destination address, acquire pathway resources from the low priority open address frame, and forward the high priority open address frame in accordance with the high priority open address frame destination address

The various embodiments disclosed herein may be implemented in a variety of ways as a matter of design choice. For example, the embodiments may take the form of computer hardware, software, firmware, or combinations thereof. Other exemplary embodiments are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary SAS architecture.

FIG. 2 is a flowchart describing an exemplary method of acquiring the partial path of a low priority OAF in the SAS architecture of FIG. 1.

FIG. 3 is an exemplary block diagram of another SAS architecture.

FIG. 4 illustrates a computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

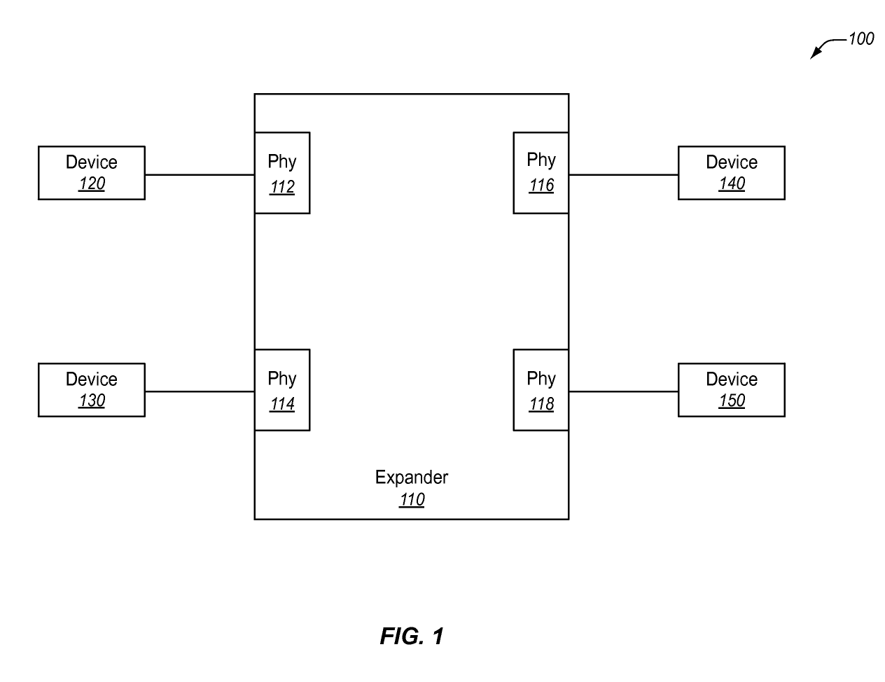

FIG. 1 is a block diagram of an exemplary SAS architecture 100 comprising an expander 110 attached to a plurality of devices 120/130/140/150 via respective phys 112/114/116/118. The devices 120/130/140/150 may include initiator/hosts and/or target devices/drives. The expander 110 is operable to manage connections and connection requests between the devices 120/130/140/150. An expander connection manager (ECM) (not shown) and/or an expander connection router (ECR) within the expander 110 may help establish and route connections between different phys. The expander 110 maps a destination SAS address in a connection request to a destination phy and also arbitrates and assigns/denies path resources for connection requests.

In order to establish a connection, a source device makes a request to establish a connection by transmitting an open address frame (OAF) to a destination device. An OAF typically contains a destination address, a source address, and other attributes that help the expander 110 route the connection request to other expanders and/or devices in the SAS architecture 100. A connection is established when an OPEN_ACCEPT command is sent by the destination device to the source device in response to the connection request made by the source device. Once established, the connection temporarily allows communication for one protocol (e.g., Serial ATA Tunneled Protocol (STP), Serial Management Protocol (SMP), and/or Serial SCSI Protocol (SSP)). The connection includes a set of physical links between a source phy and a destination phy, which is referred to as a pathway.

The expander 110 decides between requests competing for the same resources in a process known as arbitration. When a source device sends an OAF to a destination device, and the two devices are separated by multiple levels (e.g., through a chain of expanders), the OAF is arbitrated at each expander until the OAF reaches the destination device. The OAF, generally speaking, moves through two timeframes. In a first timeframe, the OAF is in the process of acquiring the pathway towards the destination device and resides in one of the expander(s) in that pathway while arbitrating for the next level. In a second timeframe, the OAF has completely acquired the pathway towards the destination device and a response is awaited from the destination device either accepting or denying the connection request.

Due to a variety of reasons, certain connection requests are deemed as having a higher priority than other connection requests in the SAS architecture 100. For the sake of simplicity, two connection requests have differing levels of priority will be referred to as a high priority OAF and a low priority OAF, although those skilled in the art will recognize that a number of different connection requests as well as a range of priority levels are possible.

The expander 110 is operable to cause a low priority OAF to release path resources and make way for a high priority OAF by sending one or more responses (e.g., backoff retry response or backoff reverse response) and/or primitives (e.g., BREAK) on the appropriate phys. By way of example, suppose that device 120 has sent a low priority OAF to device 140 through the expander 110. At the same time, device 140 has sent a high priority OAF to device 130 through the expander 110. Each of the two OAFs arbitrate for path resources and the expander 110 allows the high priority OAF to forward through phy 114 (and device 130) and blocks the low priority OAF sent from device 120 by sending a backoff retry response through phy 112. In this way, the high priority OAF is allowed to pass through the expander 110 while the low priority OAF cedes path resources and retries arbitration.

In another example, suppose that device 120 has sent a low priority OAF to device 140 through the expander 110. At the same time, device 140 has sent a high priority OAF to device 120 through the expander 110. Each of the two OAFs arbitrate for path resources and the expander 110 allows the high priority OAF to forward through phy 112 (and device 120) and blocks the low priority OAF sent from device 120 by sending a backoff reverse response through phy 112. In this way, the high priority OAF is allowed to pass through the expander 110 while the low priority OAF cedes path resources.

As illustrated in the above two examples, the expander 110 sends either a backoff retry response or a backoff reverse response depending on whether the high priority OAF destination is different than the low priority OAF source. In the first example, the high priority OAF destination (i.e., device 140) is different than the low priority OAF source (i.e., device 120). Thus, a backoff retry response is sent by the expander 110. In the second example, the high priority OAF destination (i.e., device 120) is the same as the low priority source (i.e., device 120). Thus, a backoff reverse response is sent by the expander 110.

In one embodiment, the expander 110 is operable to allow a high priority OAF to acquire the pathway of a low priority OAF for which arbitration is in progress when the source of the high priority OAF is different than the destination of the low priority OAF. The expander 110 sends backoff responses and BREAK primitives on the appropriate phys so that the high priority OAF is not kept waiting on the partial path of the low priority OAF, thereby improving the quality of service of the SAS architecture 100.

The expander 110 is a SAS expanders operable to link initiators to target devices via the SAS protocol. The expander 110 can be any device, system, software, or combination thereof operable to connect the devices 120/130/140/150 (as well as other expanders) to form a data network, or “switched fabric” via the SAS protocol. One example of the expander 110 is a wide port SAS expander. Such systems can be found in Redundant Array of Independent Disks (RAID) storage systems and other data storage networks employing disk drives.

As mentioned, the devices 120/130/140/150 may include initiator/hosts and/or target devices/drives. Target devices are any devices capable of connecting with initiators through the expander 110 and operable to respond to read and write requests generated by the initiators. Examples of the target devices include computer disk drives and other storage devices. Phys comprise any combination of hardware, software, firmware, and other associated logic capable of operating as physical transceivers between the elements disclosed herein. The initiators may be configured in separate host systems or in a single host system as part of a redundancy implementation with the host system. Each initiator may include a storage controller, or Host Bus Adapter (HBA), that processes host Input/Output (I/O) operations that are routed or otherwise switched (e.g., via the switched fabric) to communicate with the target devices.

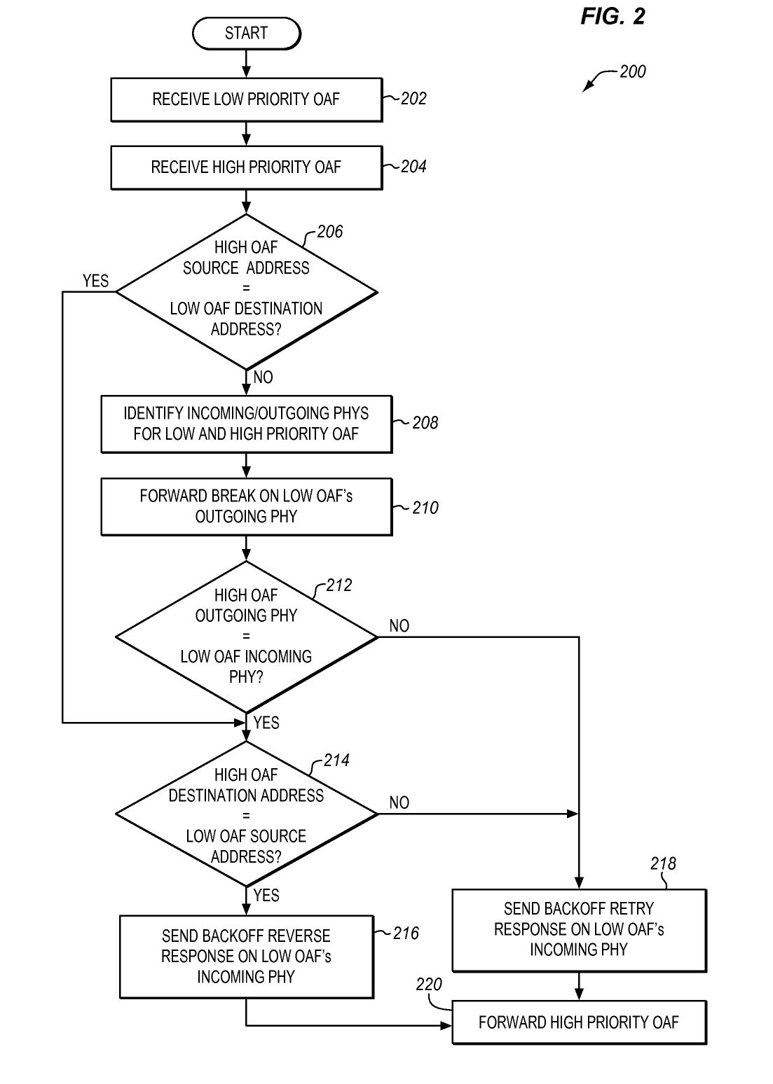

Discussion of the expander 110 will now be directed to the flowchart of FIG. 2. It should be noted that, while the SAS architecture 100 is illustrated with a certain number of devices and expanders, the embodiment is not intended to be limited to such. Rather, FIG. 1 is merely intended to concisely illustrate certain principles of a SAS architecture and the various operations of an expander. The steps of the flowchart described herein are not all inclusive and may include other steps not shown. The steps described herein may also be performed in an alternative order.

FIG. 2 is a flowchart describing an exemplary method 200 for acquiring the partial path of a low priority OAF. The method of FIG. 2 may be operable in a SAS expander such as the expander 110 described above with regard to FIG. 1. Assume for the sake of this embodiment that the SAS architecture 100 is operational and that discovery of the devices 120/130/140/150 has been performed. As the SAS architecture 100 is operational, the expander 110 routes connection requests between source devices and destination devices.

At steps 202 and 204 the expander 110 receives a low priority OAF and a high priority OAF. As discussed above, an OAF is sent by a source device to request a connection with a destination device and includes a source address and destination address associated with the source device and the destination device, respectively. It is assumed for the sake of this embodiment that the high priority OAF requires some or all of the pathway acquired by the low priority OAF for which connection request arbitration is in progress.

At step 206, the expander 110 determines whether the source SAS address of the high priority OAF is the same as the destination SAS address of the low priority OAF. When the two addresses are the same, the method proceeds to step 214 and the expander 110 next determines whether the destination SAS address of the high priority OAF matches the source SAS address of the low priority OAF. However, when the two addresses are not the same at step 206, the method proceeds to step 208.

At step 208, the expander 110 identifies one or more of the incoming and/or outgoing phys for each of the high priority OAF and the low priority OAF. The XL status of a phy can confirm whether a phy is the incoming phy for an OAF or whether it is an outgoing phy for an OAF. For instance, according to the SAS protocol, the XL status of an incoming phy receiving the OAF changes to Open_Cnf_Wait and the XL status of an outgoing phy changes to Open_Rsp_Wait after acquiring the next level path for that OAF towards the destination.

Then, at step 210, a BREAK primitive is forwarded on the outgoing phy of the low priority OAF. In other words, BREAK is forwarded on the phy with an XL status of Open_Rsp_Wait for the low priority OAF. The BREAK is forwarded through the acquired partial path of the low priority OAF. When the expander 110 receives back BREAK_REPLY from the same phy which transmitted BREAK, the low priority OAF's release of pathway resources is confirmed.

At step 212, the expander 110 determines whether the outgoing phy of the high priority OAF matches the incoming phy of the low priority OAF, or alternatively, matches the outgoing phy of the low priority OAF. In other words, the expander 110 determines whether the outgoing phy of the high priority OAF has an XL status of Open_Cnf_Wait (i.e., incoming phy) for the low priority OAF or whether the outgoing phy of the high priority OAF has an XL status of Open_Rsp_Wait (i.e., outgoing phy) for the low priority OAF. When the outgoing phy of the high priority OAF has an XL status of Open_Cnf_Wait for the low priority OAF, the method proceeds to step 214. However, when the outgoing phy of the high priority OAF instead has an XL status of Open_Rsp_Wait for the low priority OAF, the method proceeds to step 218 and the expander 110 sends a backoff retry response on the phy with the XL status of Open_Cnf_Wait for the low priority OAF so that the source of the low priority OAF will retry the connection and make way for the high priority OAF.

At step 214, the expander 110 determines whether the destination SAS address of the high priority OAF matches the source SAS address of the low priority OAF. When the two addresses match, the expander 110 forwards a backoff reverse response on the phy with XL status Open_Cnf_Wait for the low priority OAF at step 216. Otherwise, when the addresses do not match at step 214, the expander 110 forwards a backoff retry response on the phy with XL status Open_Cnf_Wait for the low priority OAF.

At step 220, the high priority OAF acquires the path resources held by the low priority OAF and is forwarded to its destination. In this way, connection acquiring delays of low priority OAFs will not block high priority OAFs even when the source of the high priority OAF is different than the destination of the low priority OAF. Further clarification can be found in the example below.

### EXAMPLE

### High Priority OAF Acquiring Low Priority OAF Partial Path

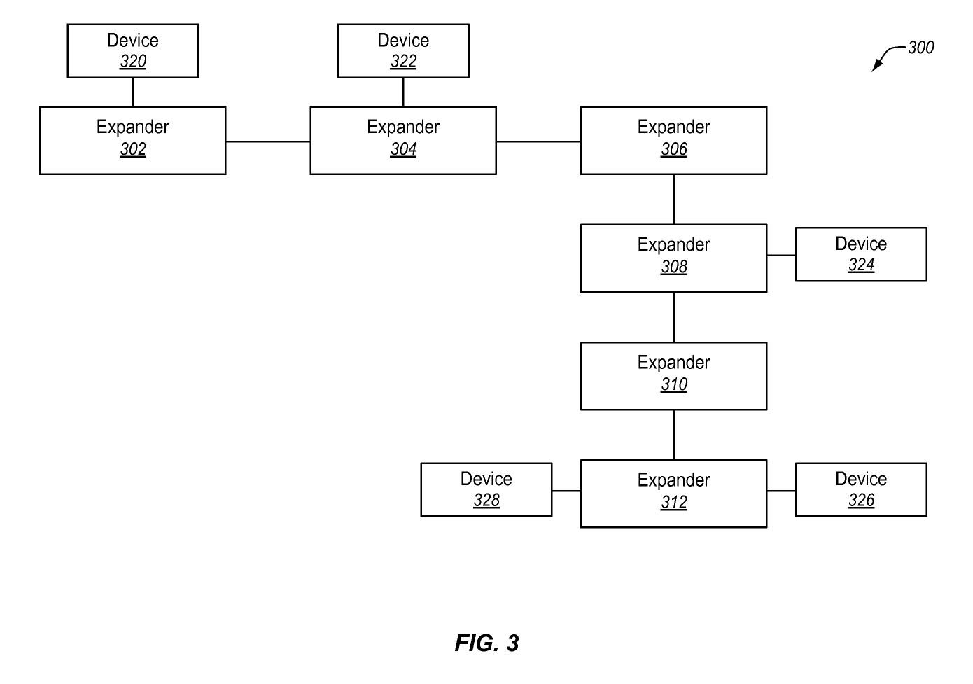

FIG. 3 is an exemplary block diagram of a SAS architecture 300. Assume for the embodiment of FIG. 3 that device 320, attached to expander 302, has sent a low priority OAF directed towards device 326 attached to expander 312. As seen in FIG. 3, device 320 and device 326 are connected through a chain of six expanders. Further assume for the sake of this embodiment that the low priority OAF has been forwarded up to expander 310, where the low priority OAF is being further arbitrated for the path towards expander 312. At the same time, device 324, which is attached to expander 308, has sent a high priority OAF to device 322, which is attached to expander 304. This high priority OAF is arbitrating for the partial path acquired by the low priority OAF.

When expander 308 receives the high priority OAF from device 324, it initiates the process to acquire the partial path resources from the low priority OAF to the high priority OAF. The source SAS address of the high priority OAF (i.e., device 324) is different than the destination SAS address of the low priority OAF (i.e., device 326). Therefore, expander 308 next identifies the incoming/outgoing phys for each OAF. In one embodiment, expander 308 identifies the phy with an XL status of Open_Cnf_Wait for the low priority OAF (i.e., the incoming phy for the low priority OAF) and identifies the phy with an XL status of Open_Rsp_Wait for the low priority OAF (i.e., the outgoing phy for the low priority OAF).

Then, expander 308 forwards the BREAK primitive sequence on the Open_Rsp_Wait status for the low priority OAF. This primitive is forwarded through the acquired pathway of the low priority OAF. Receiving back BREAK_REPLY from the same phy which has transmitted the BREAK will confirm release of pathway resource of Low Priority OAF on that path.

Then, expander 308 determines whether the outgoing phy of the high priority OAF has an XL status of either Open_Cnf_Wait or Open Rsp Wait for the low priority OAF. In this example, the high priority OAF has an outgoing phy equal to that incoming phy of the low priority OAF. In other words, the high priority OAF has an outgoing phy with an XL status of Open_Cnf_Wait for the incoming phy. Therefore, expander 308 next determines whether the destination address of the high priority OAF matches the source address of the low priority OAF. In this example, the high priority destination address is that of device 322, while the low priority source address is that of device 320. Since the addresses in this case do not match, a backoff retry response is sent on the outgoing phy of the high priority OAF. In this way, the low priority OAF is forced to retry the OAF after losing its acquired pathway which makes the same pathway available for the high priority OAF.

It should be noted that if the destination SAS address of the high priority OAF were that of device 328 attached to expander 312 (instead of device 322 as in the example), then the outgoing phy of this high priority OAF would have an XL status of Open_Rsp_Wait for the low priority OAF. In that case, expander 308 would have initiated a similar process to take pathway resources from the low priority OAF. In other words, at step 212 of the method 200 above, expander 308 would have determined that the high priority OAF outgoing phy has an XL status of Open_Rsp_Wait and would have proceeded to step 218 to send a backoff retry response on the phy with XL status of Open_Cnf_Wait for the low priority OAF.

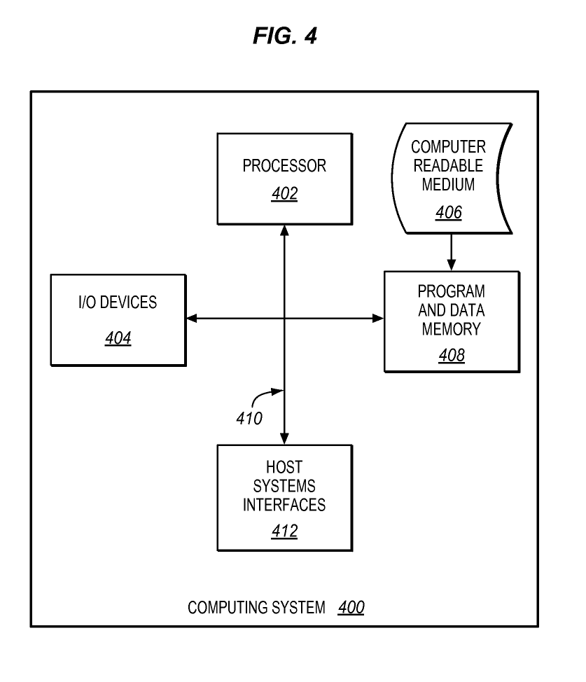

Embodiments of the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 4 illustrates a computing system 400 in which a computer readable medium 406 provides instructions for performing any of the methods disclosed herein.

Furthermore, embodiments of the invention can take the form of a computer program product accessible from the computer readable medium 406 providing program code for use by or in connection with a computer or any instruction execution system. For the purposes of this description, the computer readable medium 406 can be any apparatus that can tangibly store the program for use by or in connection with the instruction execution system, apparatus, or device, including the computing system 400.

The medium 406 can be any tangible electronic, magnetic, optical, electromagnetic, infrared, or semiconductor system (or apparatus or device). Examples of a computer readable medium 406 include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The computing system 400, suitable for storing and/or executing program code, can include one or more processors 402 coupled directly or indirectly to memory 408 through a system bus 410. The memory 408 can include local memory employed during actual execution of the program code, bulk storage, and cache memories which provide temporary storage of at least some program code in order to reduce the number of times code is retrieved from bulk storage during execution. Input/output or I/O devices 404 (including but not limited to keyboards, displays, pointing devices, etc.) can be coupled to the system either directly or through intervening I/O controllers. Network adapters may also be coupled to the system to enable the data processing system to become coupled to other data processing systems, such as through host systems interfaces 412, or remote printers or storage devices through intervening private or public networks. Modems, cable modem and Ethernet cards are just a few of the currently available types of network adapters.

What is claimed is:

1. A Serial Attached Small Computer System Interface expander operable to interconnect a destination device to a source device through a plurality of physical transceivers, the expander comprising a processor operable to:
receive a low priority open address frame that includes a source address and a destination address;
receive a high priority open address frame that includes a source address and a destination address, wherein the high priority open address frame requires at least a portion of a partial path acquired by the low priority address frame for which connection request arbitration is in progress;
determine whether the high priority open address frame source address matches the low priority open address frame destination address;
in response to a determination that the high priority open address frame source address is different than the low priority open address frame destination address, acquire pathway resources from the low priority open address frame; and
forward the high priority open address frame in accordance with the high priority open address frame destination address.

2. The expander of claim 1, the processor further operable to:
identify an incoming phy associated with the low priority open address frame, an outgoing phy associated with the low priority open address frame, and an outgoing phy associated with the high priority open address frame; and
forward a BREAK command on the outgoing phy associated with the low priority open address frame.

3. The expander of claim 2, the processor further operable to:
determine whether the outgoing phy associated with the high priority address frame is the same as the incoming phy associated with the low priority address frame; and
determine whether the high priority open address frame destination address matches the low priority open address frame source address.

4. The expander of claim 3, the processor further operable to:
send a backoff reverse response in response to a determination that: (i) the outgoing phy associated with the high priority address frame is the same as the incoming phy associated with the low priority address frame, and (ii) the high destination address matches the low source address.

5. The expander of claim 3, the processor further operable to:
send a backoff retry response in response to a determination that: (i) the outgoing phy associated with the high priority address frame is the same as the incoming phy associated with the low priority address frame, and (ii) the high priority open address frame destination address does not match the low priority open address frame source address.

6. The expander of claim 3, the processor further operable to:
send a backoff retry response in response to a determination that the outgoing phy associated with the high priority address frame is the same as the outgoing phy associated with the low priority address frame.

7. A method, comprising:
receiving a low priority open address frame that includes a source address and a destination address;
receiving a high priority open address frame that includes a source address and a destination address, wherein the high priority open address frame requires at least a portion of a partial path acquired by the low priority address frame for which connection request arbitration is in progress;
determining whether the high priority open address frame source address matches the low priority open address frame destination address;
in response to a determination that the high priority open address frame source address is different than the low priority open address frame destination address, acquiring pathway resources from the low priority open address frame; and
forwarding the high priority open address frame in accordance with the high priority open address frame destination address.

8. The method of claim 7, further comprising:
identifying an incoming phy associated with the low priority open address frame, an outgoing phy associated with the low priority open address frame, and an outgoing phy associated with the high priority open address frame; and
forwarding a BREAK command on the outgoing phy associated with the low priority open address frame.

9. The method of claim 8, further comprising:
determining whether the outgoing phy associated with the high priority address frame is the same as the incoming phy associated with the low priority address frame; and
determining whether the high priority open address frame destination address matches the low priority open address frame source address.

10. The method of claim 9, further comprising:
sending a backoff reverse response in response to a determination that: (i) the outgoing phy associated with the high priority address frame is the same as the incoming phy associated with the low priority address frame, and (ii) the high destination address matches the low source address.

11. The method of claim 9, further comprising:
sending a backoff retry response in response to a determination that: (i) the outgoing phy associated with the high priority address frame is the same as the incoming phy associated with the low priority address frame, and (ii) the high priority open address frame destination address does not match the low priority open address frame source address.

12. The method of claim 9, further comprising:
sending a backoff retry response in response to a determination that the outgoing phy associated with the high priority address frame is the same as the outgoing phy associated with the low priority address frame.

13. A non-transitory computer readable medium embodying programmed instructions which, when executed by a processor, are operable to perform the steps of:
receiving a low priority open address frame that includes a source address and a destination address;
receiving a high priority open address frame that includes a source address and a destination address, wherein the high priority open address frame requires at least a portion of a partial path acquired by the low priority address frame for which connection request arbitration is in progress;
determining whether the high priority open address frame source address matches the low priority open address frame destination address;
in response to a determination that the high priority open address frame source address is different than the low priority open address frame destination address, acquiring pathway resources from the low priority open address frame; and
forwarding the high priority open address frame in accordance with the high priority open address frame destination address.

14. The medium of claim 13, the steps further comprising:
identifying an incoming phy associated with the low priority open address frame, an outgoing phy associated with the low priority open address frame, and an outgoing phy associated with the high priority open address frame; and
forwarding a BREAK command on the outgoing phy associated with the low priority open address frame.

15. The medium of claim 14, the steps further comprising:
determining whether the outgoing phy associated with the high priority address frame is the same as the incoming phy associated with the low priority address frame; and
determining whether the high priority open address frame destination address matches the low priority open address frame source address.

16. The medium of claim 15, the steps further comprising:
sending a backoff reverse response in response to a determination that: (i) the outgoing phy associated with the high priority address frame is the same as the incoming phy associated with the low priority address frame, and (ii) the high destination address matches the low source address.

17. The medium of claim 15, the steps further comprising:
sending a backoff retry response in response to a determination that: (i) the outgoing phy associated with the high priority address frame is the same as the incoming phy associated with the low priority address frame, and (ii) the high priority open address frame destination address does not match the low priority open address frame source address.

18. The medium of claim 15, the steps further comprising:
sending a backoff retry response in response to a determination that the outgoing phy associated with the high priority address frame is the same as the outgoing phy associated with the low priority address frame.
